(19) United States
(12) Patent Application Publication
(10) Pub. No.: US 2004/0122716 A1
(43) Pub. Date: Jun. 24, 2004

(54) Virtual service system for client and service provider users and method therefor

(76) Inventor: Kanagasingam Yogesan, Nedlands (AU)

Correspondence Address: FROMMER LAWRENCE & HAUG, 745 FIFTH AVENUE- 10TH FL., NEW YORK, NY, 10151, US

(21) Appl. No.: 10/683,494

(22) Filed: Oct. 10, 2003

Related U.S. Application Data
(63) Continuation-in-part of application No. PCT/AU02/00454, filed on Apr. 10, 2002.

(30) Foreign Application Priority Data
Apr. 10, 2001 (AU) PR4327

(51) Int. Cl. G06F 17/60

(52) U.S. Cl. 705/2; 705/1

(57) ABSTRACT

An electronic healthcare system comprises a number of stations (12) connected either via a LAN or via the Internet. Client service stations (13) are used to capture and process digital images that are then uploaded to a central service station (21). Primary service stations (14) and specialist service stations (15) allow healthcare specialists and primary healthcare providers to access the uploaded multimedia information to provide diagnosis and treatment as well other services. An administrator station (16) and one or more analysis stations (18) allow the system to be administered as well as data analysis to be performed. Access to the data is granted on a permission basis. The system cab have applicability in many healthcare scenarios, but is particularly applicable for ophthalmic and dentals screening, diagnosis and treatment.

### REFERENCE TO RELATED APPLICATIONS

This application is a continuation-in-part application of International Patent Application PCT/AU02/00454 filed Apr. 10, 2002 and published as WO 02/084511 on Oct. 24, 2002, which claims priority to Australian Provisional Patent Application PR 4327 filed Apr. 10, 2001.

Each of the foregoing applications and patents and articles, and each document cited or referenced in each of the foregoing applications and patents and articles, including during the prosecution of each of the foregoing applications and patents (“application and article cited documents”), and any manufacturer's instructions or catalogues for any products cited or mentioned in each of the foregoing applications and patents and articles and in any of the application and article cited documents, are hereby incorporated herein by reference. Furthermore, all documents cited in this text, and all documents cited or referenced in documents cited in this text, and any manufacturer's instructions or catalogues for any products cited or mentioned in this text or in any document hereby incorporated into this text, are hereby incorporated herein by reference. Documents incorporated by reference into this text or any teachings therein may be used in the practice of this invention. Documents incorporated by reference into this text are not admitted to be prior art. Furthermore, authors or inventors on documents incorporated by reference into this text are not to be considered to be “another” or “others” as to the present inventive entity and vice versa, especially where one or more authors or inventors on documents incorporated by reference into this text are an inventor or inventors named in the present inventive entity.

### FIELD OF THE INVENTION

This invention relates to a virtual service system for users involving information acquisition, transfer, storage and access amongst clients and service providers that may be located remotely of each other, and a method therefor. The invention has particular, but not exclusive, utility with the provision of complex services to clients involving the interaction of different types of service providers with information acquired from the client, such as those relating to medicine and health care.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The delivery of complex services to clients involving the interaction of different types of service providers with information acquired in respect of the client has traditionally been performed in a sequential and fragmented manner. In some service areas, the manner of communication of information between service providers follows established protocols that can only be supported by the communication infrastructure found in an urban area. Thus persons located remotely from urban areas or service providers having the requisite expertise to deliver such services tend to be disadvantaged by having to travel to urban areas or locations where such services can be provided. Oftentimes such travel is inconvenient or inappropriate, in which case these persons simply do without the provision of the service.

Although this may be acceptable to an extent in the case of the provision of non-essential services, it is not particularly acceptable to the larger community in the case of essential services such as those related to medicine and health care.

Indeed, even in the delivery of complex services of the nature described in urban areas where access to service providers with the requisite expertise is available, the protocol observed in gathering information from a client by one service provider, referring it to another service provider for special consideration, recommending further information to be gathered by the referring service provider for further consideration, advising the referring service provider of a proposed course of action etc, can be cumbersome and time consuming.

In the case of services related to medicine and health care, some progress has been made in addressing the provision of high-level medical services to remote areas with the development of telemedicine, that is the provision of healthcare delivery by remote examination by physicians using telecommunications technology, and telehealth (recently defined as “healthcare at a distance”). Indeed, telemedicine and telehealth technology has been developing for over 35 years, and thus has grown around direct connection telecommunication links such ISDN telephone lines or level T1 data lines.

With the relatively recent acceptance and widespread use of Internet technology into remote areas of the globe, it is logical that the telehealth and telemedicine services develop using Internet technology to provide a much cheaper and more widely accessible service to users. A new term has been coined to describe the provision of wider healthcare services, particularly using the Internet, such as medical advice and diagnosis, information and distance education, and healthcare services administration—“E-Health”. E-Health is therefore the combined use of electronic communication and information technology in the healthcare sector. Telemedicine and telehealth are subsets of E-Health.

The potential for delivering complex services such as those relating to medicine and healthcare to the home in first and second world countries, and to people in third world countries as a result of the Internet is enormous.

Internet communications are much cheaper and more accessible than using networks based on ISDN phone lines or T1 lines. Thus studies into the delivery of healthcare services via the Internet have predicted that virtually all homes will be equipped with virtual health agents to screen for disease by the year 2015.

With the Internet has come a rash of business related schemes that have been generally classified under the tag of e-commerce, where a virtual service can be offered and delivered to a customer using client/server technology with the Internet being the preferred communication medium linking computers of the customer and the service provider. Examples of such services include the retailing of books, under the well known Amazon.com™ banner, and the provision of business printing services, under the ImageX.com™ banner.

These virtual services have a reasonably innovative and sophisticated ordering and supply network associated with them, and have been the subject of patent protection in some countries. Insofar as the entire realm of services is concerned, however, these types of services fall into the ‘simple’ category, effectively involving straight retailing or very simple service delivery. When considering the delivery of more complex services involving a variety of professional service providers and deeper client/service provider interactions, such as services related to medicine and healthcare, the logistics of providing a virtual service are more problematic and the technical requirements and overheads associated therewith are far more demanding, making such virtual services more difficult to design and implement.

The staggering growth in digital technology, however, principally due to the low cost of computer technology, and the advances made in the telemedicine and telehealth fields, have now made it possible to provide such complex services as a virtual service.

In European Patent Application No. 99305008.7 there is disclosed a general telemedicine application for the screening of cervical cancer. A system for capturing an image and transmitting it to a remote location for storage/diagnosis is disclosed. Clinicians can then select a diagnosis from a list of available options.

PCT Patent Application No. PCT/US00/04143 discloses a system where medical information can be sent to a remote location via a serial bus.

U.S. Pat. No 6,033,076 discloses a system for downloading software for screening for glaucoma using the Internet.

### DISCLOSURE OF THE INVENTION

Accordingly, it is an object of the present invention to provide a relatively complex E-Health service involving a plurality of service providers and clients and the transfer of data therebetween, as a virtual service.

According to a first aspect of the invention, there is provided virtual service system for providing a service to a client, the system comprising:

a client service station for acquiring information about the client, and providing to a user thereat a plurality of client processes for acquiring said information in a controlled and regulated manner;

a central server station for receiving and storing the acquired information about the client in a prescribed manner, the central server station comprising multiple discrete servers;

a primary service provider station for facilitating the acquisition and transfer of said information to said central server station: and

a specialist service provider station for accessing information stored at the central stored at the central server station, and providing to the user thereat a plurality of specialist processes in a controlled and regulated manner.

The discrete servers of the central server station may each receive and store acquired information of a predetermined type. Further, the specialist service provider station can be configures to access information stored at the central server station by having the central server station transmit the information to the specialist service station in accordance with a prescribed protocol at a time specified by the specialist service station. In one arrangement, the prescribed protocol includes transmitting a low-resolution image at first instance and, thereafter, allowing a region of interest of the image to be selected at the specialist service provider station and transmitting the portion of the image equating to the region of interest at full resolution.

The client processes may also include vital client information gathering means, specialist service provider selection means, multimedia information grabbing means, multimedia information uploading means to said central server station, information submission means to said central server station, and specialist service provider advisory means to said specialist service provider station.

The specialist processes may include processes for accessing, processing and editing the information, and include client information accessing means, reviewing and editing means of said information, reporting means in respect of said information, information submission means for submitting the edited and reported aspects of said client information to said central server station, and primary service provider advisory means to said primary service provider station.

The primary service provider station may have a prescribed primary level access to the information stored at the central server station, and the prescribed primary level access permitting only reading of the information.

The specialist service provider station may have a prescribed specialist level access permitting reading and writing of the information.

The virtual service system as previously described, may be implemented in a manner wherein the primary service provider station corresponds to the client service station. Alternatively, the primary service provider station may be discrete from the client service station.

The virtual service system may further include an administrator station for providing to a user thereat a plurality of administrative processes for administering the system in a controlled and regulated manner.

The administrative processes may include specialist updating means, user statistic providing means, user updating means, medical centre updating means, and searching means for searching information stored at the central server station.

The virtual service system may further include an analysis station for providing to a user thereat a plurality of analysis processes for providing an analysis of the information stored in the system in a controlled and regulated manner.

The analysis processes may include criteria searching means, report providing means, and information display means.

The information display means may include patient display means and/or a result display means.

According to another aspect of the present invention, there is provided a method for providing a service to a client as a virtual service, the method including the steps of:

acquiring information about a client at a client service station by following a plurality of client processes in a controlled and regulated manner;

transferring the information to a central server station comprising multiple discrete servers where the information is stored in a prescribed manner;

facilitating the acquisition and transfer of said information to the central server station via a primary service provider station; and

accessing the stored information at the central server station from a specialist service station by following a plurality of specialist processes.

The method may further include the step of apportioning information stored at the central server station according to predetermined types—each discrete server designated for the storage of information of the respective predetermined type receiving the apportioned information of that type.

The method may include the step of accessing the stored information at the central server station from a specialist service station comprises transmitting the information from the central server station to the specialist server station in accordance with a prescribed protocol at a time specified by the specialist service station. The prescribed protocol itself may comprise the steps of:

receiving a low-resolution image at first instance at the specialist service provider station;

optionally selecting a region of interest of the image;

transmitting details of the selected region of interest to the central server station; and

receiving a full resolution image of the portion of the image equating to the region of interest.

The client processes may include gathering vital client information, selecting a specialist service provider, grabbing multimedia information as appropriate, uploading the multimedia information to the central server station, submitting the client information to the central server station, and advising the selected specialist service provider in relation to the client information.

The method may further include the steps of processing and editing the accessed and stored information, from the specialist service station.

The specialist processes may include accessing the client information, reviewing and editing of said information, reporting in respect of said information, submitting the edited and reported aspects of said client information to said central server station, and advising the primary service provider at the primary service provider station.

The primary service provider station may have a prescribed primary level access to the information stored at the central server station, the prescribed primary level access permitting only reading of the information.

The specialist service provider station may have a prescribed specialist level access permitting reading and writing of the information.

The method may further include the step of providing to a user, via an administrator station, a plurality of administrative processes for administering the system in a controlled and regulated manner.

The administrative processes may include specialist updating means, user statistic providing means, user updating means, medical centre updating means; and searching means for searching information stored at the central server station.

The method may further include the step of providing to a user, via an analysis station, a plurality of analysis processes for providing an analysis of the information stored in the system in a controlled and regulated manner.

The analysis processes may include criteria searching means, report providing means; and information display means.

The information display means may include a patient display means. Alternatively, the information display means may include a result display means.

The invention is particularly applicable to delivering a virtual eye care service through the Internet using ophthalmic screening processes requiring the involvement of:

patients being screened for eye care as clients,

primary service providers such as general practitioners, optometrists, nurses, midlevel health personnel etc, and

ophthalmologists as specialist service providers.

The typical ophthalmic screening process essentially comprises:

Screening/diagnosis by a skilled ophthalmologist in person.

Diagnosis of the major ophthalmic conditions/diseases performed by reference to images of the eye (direct or photographic).

Having particular regard to those areas of the eye where major diseases occur, namely in the front of the eye e.g. cataract and in the back of the eye (1) diabetic retinopathy; (2) glaucoma; and retinal detachment.

Reporting of the diagnosis is handwritten or dictated in a letter for patient records, typically with a photograph(s) taken of the eye, developed and kept on the patient files.

Patient is referred to the ophthalmologist from a General Practitioner or optometrist.

Optometrist usually reviews the patient with a slit-lamp (as well as the refractive consultation) but does not perform a diagnosis—refers to ophthalmologist if the optometrist has any concerns with the patient.

About 80% of the ophthalmologist's time is spent in this screening.

About 80% of the patients screened by the ophthalmologist are OK (normal), 16% need active monitoring of a potential condition and about 4% require treatment.

The best mode of the invention will be described in relation to the provision of an ophthalmic screening process using a virtual service provided via the Internet, with reference to the accompanying drawings.

### BRIEF DESCRIPTION OF THE DRAWINGS

FIG. 1 is a schematic diagram showing the basic physical layout of the client/server virtual service system;

FIG. 2 is a schematic diagram showing the basic hardware configuration of the client service station as connected to the central server station;

FIG. 3 is a schematic block diagram showing the logical structure of the client service station personal computer (PC) and the central server station PC;

FIG. 4 is a flow chart showing the logical flow of information and processes between the main hardware components of the virtual system;

FIG. 5 is a schematic block diagram showing the screening processes used in the virtual service system;

FIG. 6 is an example of a web page provided for a primary service provider to log on to the virtual service system;

FIG. 7 is an example of a web page provided for gathering the vital client information;

FIG. 8 is an example of a web page provided for uploading the multimedia information for storage with the central service provider server;

FIG. 9 is a schematic block diagram showing the administrator processes used in the virtual service system;

FIG. 10 is a menu web page used by an administrator of the virtual service system;

FIG. 11 is a schematic block diagram showing the analysis processes used in the virtual service system; and

FIGS. 12 to 18 are web pages provided for some of the administrator processes shown in FIG. 9.

### BEST MODE(S) FOR CARRYING OUT THE INVENTION

The best mode of the invention will be described in relation to a specific embodiment of the virtual service system and method therefor related to the ophthalmic screening of patients for eye care purposes.

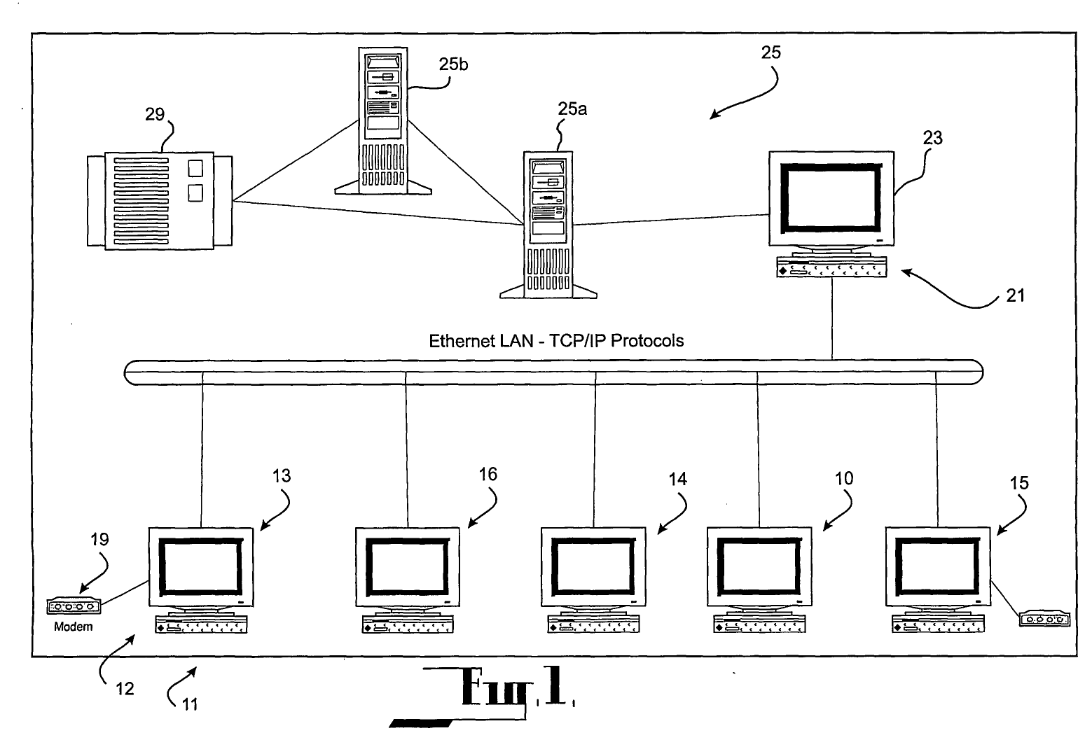

As shown in FIG. 1 of the drawings, the virtual service system 11 comprises a plurality of clients 12 including one or more client service stations 13, one or more primary service provider stations 14, one or more specialist service provider stations 15, one or more analysis stations 18, and an administrator station 16—each of which include a PC—and a central server station 21, all of which are connected into a computer network by an Ethernet Local Area Network (LAN) 17 using TCP/IP protocols, and/or via a modem 19 using the Internet. In the embodiment described herein, the client service stations 13 are used to capture and process digital images of an ophthalmic source 38, and to upload these images to the central server station 21, as will be described in more detail below. The primary service provider stations 14 are used by primary service providers such as GP's, optometrists, or other primary healthcare professionals. The specialist service provider stations 15 are used by secondary healthcare specialists such as ophthalmologists. This will be described in further detail below. The administrator station 16 is used by an administrator of the system 11, and the analysis stations 18 by users of the system 11 for data analysis—as will also be described in more detail below. The different service stations 13, 14, 15, 16 and 18 may be located in separate locations. However, a client service station 13, and a primary service provider station 14 may be located together, and may even be integrated as a single unit—as may some of the other stations. The client service station 13 and primary service station 14 can also be the same—in that the primary service station 14 can be used to capture and process digital images of an opthalmic source. As an example, a client service station 13 could be located in a remote country location, and operated by a suitably trained professional such as a nurse, while the primary service provider station 14 could be located at a GP surgery, and while the specialist service provider station 15 could be located in a specialist's consulting room at a hospital located some distance away.

The central server station 21 comprises an application Web server 23 for interfacing with the computer network, an authentication web server 22, a multimedia database server 25, which includes an information database server 25a and an image database server 25b, and mass storage media 29 principally for storing the images managed by the image database server 25b, but also for storing database information derived from the information database server 25a, all of which combine to form a database management system (DBMS) that can be accessed via the aforementioned client stations.

The DBMS of the present embodiment is particularly configured to handle the storage and retrieval of complex multimedia information to provide an ophthalmologist with the necessary information to deliver a specialist service to clients via the virtual service system 11.

The PCs for each of the client stations are required to be equipped with a central processing unit (CPU) 31 that can operate at a speed of 600 Mhz or higher, an Internet browser 33, such as Internet Explorer™, and at least a 56K modem 35 for connecting to the Internet 36.

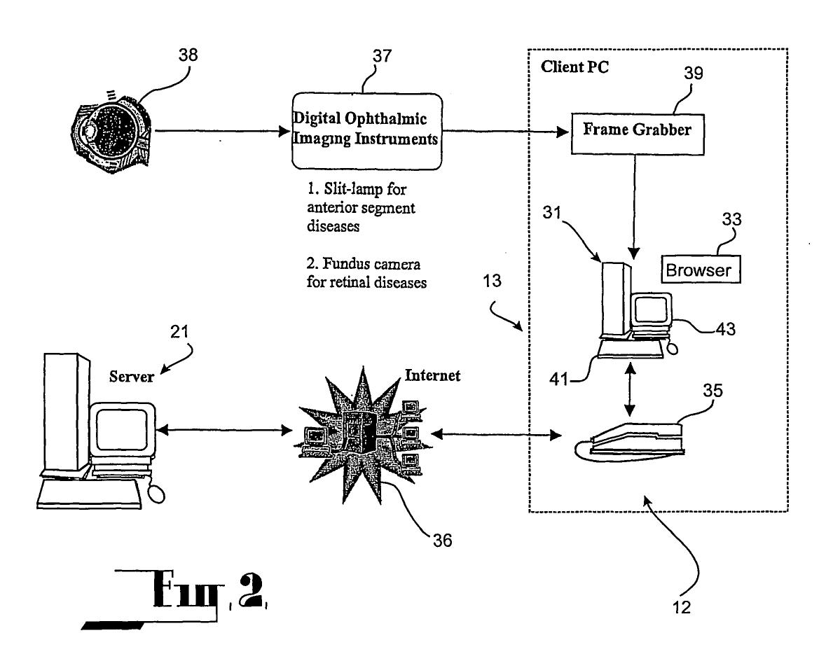

In the case of the client service provider station 13, as shown in FIG. 2, suitable digital image information capturing instruments 37 for obtaining optical images of an ophthalmic source 38 and textual information documenting equipment for capturing and inputting information into the PC relating to the ophthalmic source 38 needs to be provided, together with appropriate operating software such as a frame grabber 39.

Digital image information capturing instruments 37 for ophthalmic screening purposes include fundus cameras, slit lamps, scanning laser ophthalmoscopes (SCO) and retinal cameras. These instruments are relatively low-cost and easy-to-operate to produce diagnostic quality images and videos and can be connected directly to the PC at the client service station 13 (or the primary service provider station 14—where appropriate).

The usual keypad 41 and monitor 43 with suitable word processing or text editor software provides documenting of textual information. Frame grabbing software 39 interfaced with the digital image information capturing instruments 37, connected to the PC via a frame grabber card, enables the capturing of image information for uploading to the central server station 21. The image is captured using any suitable image-capturing device provided with the instrument 37—such as an image capture card coupled to the PC via the IEEE 1394 of the PC.

In the case of the central server station 21, traditional DBMS's used in the medical field are not capable of handling complex multimedia information (i.e., text, images, graphics, and voice data). The purpose of developing a multimedia database in ophthalmology is to provide the ophthalmologist with the necessary information to generate diagnostic reports, i.e. patient's history, other clinical data and high quality colour images, which will help the ophthalmologist in their decision making. A multimedia ophthalmic database also provides information to help solve unusual medical problems and make it possible to access existing information about similar or closely related cases. It can also be used for educational purposes, e.g. a student would be able to access and study patient records and images with specific diseases subject to ethical approval or with a bar on personal details.

Generally speaking, there are four approaches to medical information database design, the relational, the network, the hierarchical and the entity-relationship medical database. The relational medical databases have had tremendous impact on medical database management because of their simple and concise characteristics. Therefore, the integration of multimedia data with the relational model is used as the basis of the DBMS in the present embodiment.

One of the key requirements of the DBMS in the integration of the storage of multimedia information with a relational model for the delivery of ophthalmic screening services is fast access by client stations to images stored at the central server station 21 through the computer network. Thus the multimedia database server 25 is specifically designed for the handling of patient information along with the diagnostic reports, images, and voice annotation. For clarity, the term “image” will be used to mean both still and moving images within this specification—unless specified otherwise.

The database server 25 is accessed by any of the client stations through the computer network using appropriate application protocols. The information database server 25a and the image database server 25b are intentionally discrete of one another in order to enable fast access to information managed thereby. Although not described in the present embodiment, an alternative embodiment includes a separate server for voice in order to further increase the speed of access to stored audio information.

The reason for having discrete multimedia database servers is that if a single multimedia database server designed for storage and handling of multimedia information (e.g. diagnostic reports, images and voice annotations) is used, and the application consists of a large database, the response time becomes a very important factor. This is especially critical in a medical environment where doctors may need specific information in a very short time. Such an environment would see many users needing to access the database and download images at the same time. Thus if the network bandwidth is limited, then a single multimedia database server can completely slow down the transmission of information to clients.

In ophthalmology, high-resolution colour images are used for diagnosis, which take up network bandwidth. Thus providing multiple database servers does not totally address the problem associated with the speed of transmitting high-resolution colour images to clients. Accordingly, the present DBMS is also designed to adopt a prescribed protocol for the transmission of image information to client stations, in a manner that reduces the load on the central server station.

This prescribed protocol will be described in more detail below, together with other factors that are taken into consideration in the design of the DBMS to meet the access speed requirements for image information stored on the system. These will now be described in turn.

(A) Prescribed Protocol for Image Information Access

Due to limited network bandwidth, the size of the images (sometimes greater than 1024×1024×3 bytes), the resolution of the screen, the storage capacity at the clients PCs, and the need for rapid display, the DBMS of the present embodiment is configured to provide a low-resolution image for transmission and display to requests of same by client stations in the first instance. Thus in response to a request from an ophthalmologist at a specialist service provider station 15, a low-resolution version of the original image is made available for display initially. If the ophthalmologist wants to study a given region, then the DBMS is designed to accommodate a zoom request from a specialist service provider station 15 sent to the image server 25b. The DBMS is designed to respond to a zoom request by transferring the full resolution of the region of interest to the specialist service provider station 15. This is not limited to accesses of the central server station 21 by specialist service provider stations 15 and thus other stations, such as a primary service provider station 14 or a client service provider station 13, subject to access level privileges, can have the full resolution image displayed at their workstation on request by a patient's doctor.

(B) Multimedia Information Management and Retrieval

Different retrieval strategies can be used to efficiently access information from the DBMS at the central server station 21. The choice of suitable retrieval methods is dependent on the data model. In a relational data model, a different relation scheme is used to represent information about a particular entity; e.g. a doctor relation scheme will contain information about the doctor such as an identification number, name, address, and telephone number. An extension of a relation scheme can be represented as a table. A collection of tables is called a folder, which is also defined as a collection of documents such as patient's information, reports, and images that can be manipulated as a whole. Each folder contains a set of attributes that can be combined in a search query. In addition to text attributes, a patient folder in a relational data model contains “Image Source Tables”. A patient may have images taken with different sources; e.g. fundus camera, stereo fundus camera, video slit lamp, whereby many images can be obtained from each source. Thus there is an “Image Source Table” and each source has a pointer to an “Image Table”. Each image attribute/record in the “Image Table” contains the logical locations of the images in the image storage system and the technical information about each image.

(C) Multimedia Database Server Setup

Some of the users may retrieve only text information from the DBMS and others may retrieve images as well. If many want to retrieve images at the same time then it will slow down the access time for the information database (text). Accordingly, the two different servers at the central server station 21, the information database server 25a and the image information server 25b reduce this access time access time. The information database server 25a provides the handling of the overall patient information and related medical data (e.g. diagnostic reports and examination details). The image information server 25b is dedicated to the management and storage of images. There is a logical link between the patients' information in the information database server 25a and the images stored in the mass storage media 29. Queries related to images and image sources are directed to the image information server 25b, which retrieves the actual image from the mass storage media 29. For additional security, images can be sent to and from the image information server 25b via an FTP server. Authentication for the FTP server is confirmed automatically. If the FTP authentication is not approved then images cannot be transmitted to and from the image information server 25b. The images do not carry any information about the patient or the doctor. Each image is also given a random file name. If the image transmission is interfered by an unauthorised person then he/she will not be able to get more information other than the actual image from the image data.

If the authentication is confirmed by the FTP server then the images will be transferred to the image information server 25b and the information database will be updated with appropriate links to the images, videos and audio files.

(D) Image Capture or Digitisation

The existing archived photographs, negatives and slides have to be stored electronically and integrated with the appropriate patient's information. This is very important in order to have a complete database of all the patients; i.e. some patients may be followed up every year. Digitisation of the existing images is thus performed using a flatbed or slide scanner.

In order to capture images directly from the eye examination equipment, CCD or digital cameras are connected to eye examination equipment such as photo slit lamp, fundus camera and SLO, as previously mentioned. The analog signals coming from CCD cameras are digitised using frame grabbers attached to PCs.

(E) Image, Video and Audio Formats

TIFF, DICOM, GIF, BMP, JPEG (lossless compression), JPEG 2000 and Wavelets are some of the widely used still image formats. The choice of image format will influence the integration of the images and data from this multimedia database with other programs. Since storage space is an important factor to be considered in the design of multimedia databases, JPEG image format with lossless compression, JPEG and Wavelets are considered to be a better choice for still images and thus is used by the DBMS. It is possible to convert between different formats such as TIFF, GIF and also DICOM formats. A function is embedded in the database program that does these conversions.

Video formats that can be used by the system include MPEG4 and AVI formats.

The audio format used is the popular MP3 format.

(F) Image Compression

Image compression is the process of reducing the size of image files. It can either be lossy or lossless compression. Images stored in the database may be used for research purposes and therefore loss of minute information may influence the analysis. Since no information is desired to be lost from the images due to compression, the lossless compression method is used by the DBMS. Lossless compression normally reduces storage by about 50 percent. However, not all the images respond to compression in the same manner.

JPEG is a widely used compression algorithm for still images and MPEG for video images. The main advantage with the JPEG format is that most of the imaging tools will read/write and visualize JPEG format images. Wavelet compression algorithms are also becoming widely used. Research on the compression of high quality colour retinal images from a fundus camera indicates that, by compressing the images, size can be reduced from 1.3 MB to 20-70 KB. The image quality is still excellent where vital information necessary for diagnosis of each major disease group is preserved.

Therefore, the present embodiment uses an adaptive compression algorithm that applies less or no compression to the region of interest (for diagnosis of glaucoma optic disk and surrounding area are of particular interest) and high compression to the rest of the area or background, for compressing image information for storage purposes.

(G) Image Storage

Since the image files are so large, image storage is an important factor to be considered when designing the image database. The disks with the quickest access time are more expensive and have comparably smaller capacity.

Magnetic tapes and optical disks are cheaper and have larger capacity but with slower access time. Therefore, a trade-off between storage cost and capacity on the one hand and access speed is made. Currently available mass-storage options include:

1) Magnetic tape in a jukebox

2) Optical disks such as re-writeable CD-ROM in jukebox

3) Large magnetic hard disks in a stack

4) DVD-ROM

5) Redundant Arrays of Inexpensive/Independent Disks (RAID)

Magnetic hard disks are faster (same as normal hard discs found in personal computers), larger storage capacity and cheaper. Therefore, stacked large magnetic hard discs are used to constitute the mass storage media 29 for storage of images.

Having regard to all of the above factors the DBMS at the central server station 21 is best constructed using:

(i) SQL or other database software for the multimedia database servers 25,

(ii) Web application server software, such as ColdFusion Studio™ and ColdFusion Server™ for the front end Web applications of the application Web server 23,

(iii) frame grabbing software for handling images, such as developed under Visual C++ and Visual Basic,

(iv) a server operating system, such as MS Windows 2000 Server™,

(v) HTML language and JAVA language software for Web based communications.

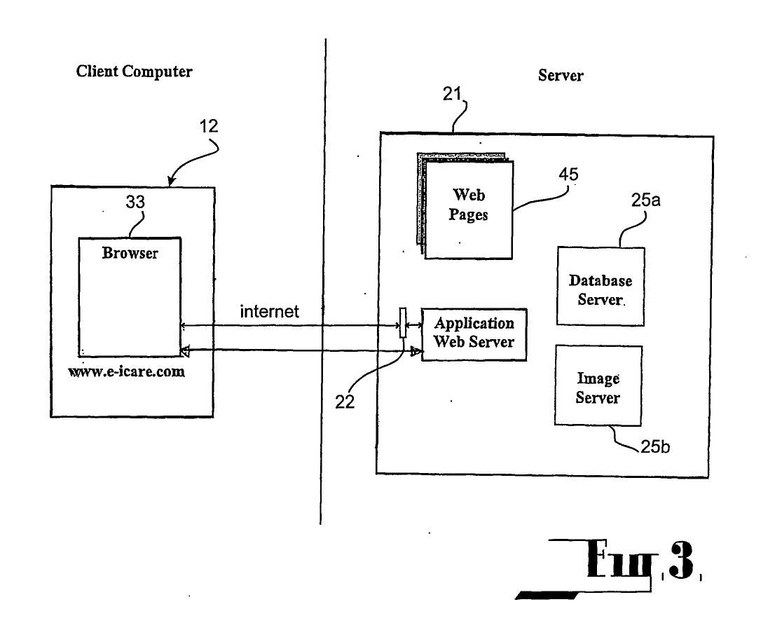

The logical configuration of the client/server system 11 using the Internet 36 as the communication network is shown in FIG. 3 of the drawings. As shown, the PC of the client stations 13, 14 and 15 uses its Web browser 33 to access the Web site, eg www.e-icare.com, hosted by the central server station 21 via the Internet 36. The application Web server 23 manages accesses to its Web site downloading Web pages 45 in HTML and JAVA format (or any other suitable Internet or web programming language) to appropriate clients depending upon their access level privileges and the particular process being undertaken by them. Access to the multimedia database servers 25 is undertaken depending upon the process being performed, which will now be described in more detail. When a client first access the central server station 21, the user will log in using a password and username typed on a web page in static HTML. This information is then sent to the authentication web server 22, which is in communication with the web application server 23 for proper authentication. If the authentication is approved then the web application server 23 communicates directly with the client stations 12 and will receive commands and data directly via static and dynamic web pages. The username and password will be verified via a Secure Socket Layer protocol and a digital certificate.

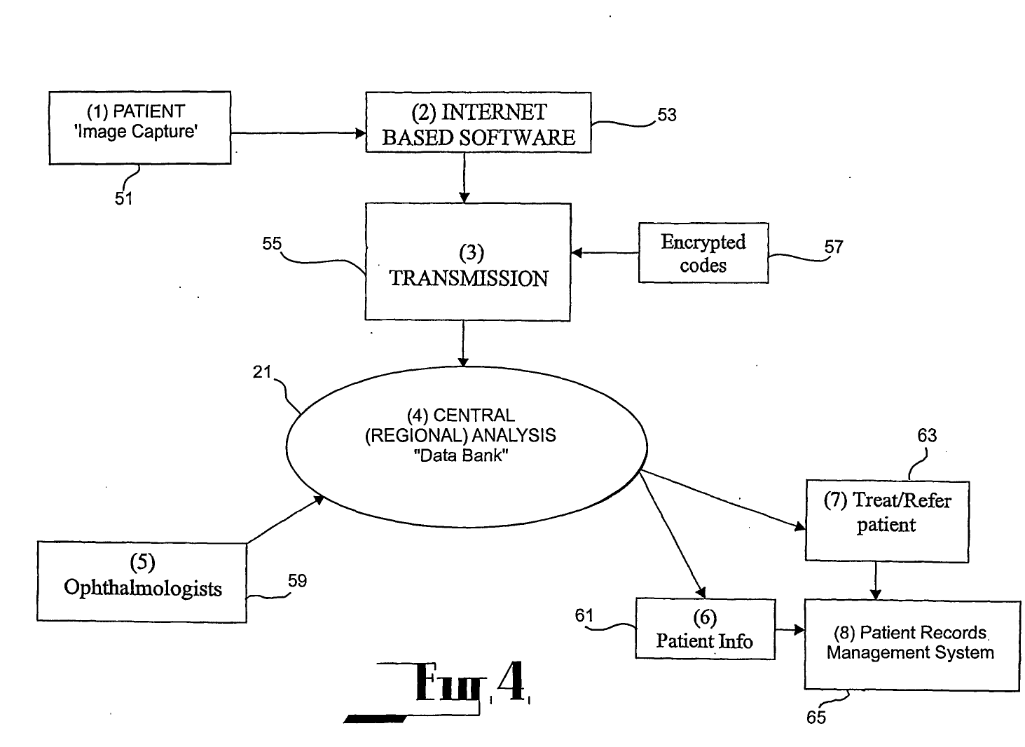

To gain an understanding of the processes performed regard will be made to the business method or concept of the virtual service system insofar as ophthalmic screening is concerned. This is described with reference to FIG. 4 of the drawings.

The business method or concept of the virtual service system 11 is concerned with obtaining digital images of ophthalmic sources of a patient (i.e. the left or right eye) and screening these images for major ophthalmic diseases using the Internet for communicating between the various professional service providers, such as GP's optometrists, and ophthalmologists, that need to be involved for conducting the screening. The method essentially involves the following steps:

Digital image gathering 51 is performed using all or some of the various digital ophthalmic imaging instruments 37 previously described either at an optometrist or other client service station 13.

Internet based software 53 is used to gather, store, compress and transmit the images from the client service station 13.

Transmission of images 55 via the Internet 36 to the central server station 21, which may function as a regional data bank, is performed using encryption 57 as appropriate.

Consulting or subscribing ophthalmologists review images 59 for diagnosis of disease.

Software system 61 is used for storing all images and diagnosis records

System followed for transmitting diagnosis report 63 to the referring (screening) agent acting as the primary service provider

System followed for scheduling new appointments and billing 65

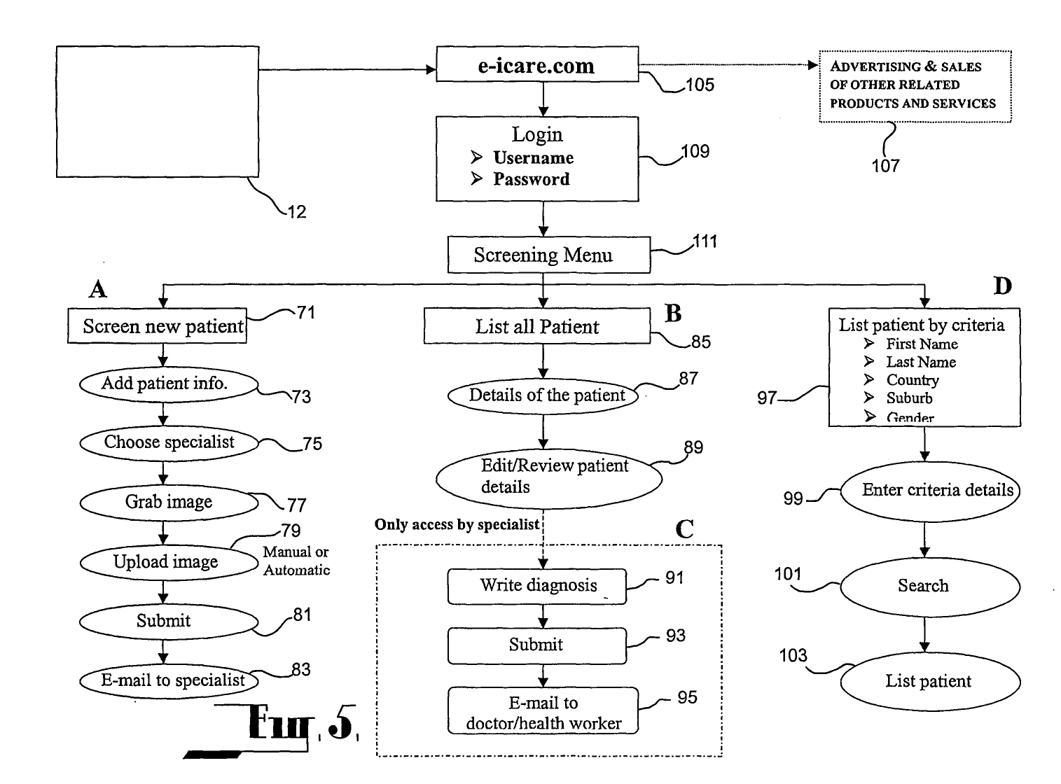

Now having regard to the specific processes undertaken at the client service station 13, primary service provider station 14, and the specialist service provider station 15, reference is made to FIG. 5 of the drawings.

Firstly, having regard to the client service station processes 71, the following processes are provided for and performed in a controlled and regulated manner 20 by virtue of the Web pages downloaded to the client service station 13 by the application Web server 23:

(i) vital client information gathering means 73 for gathering vital client information particulars;

(ii) specialist service provider selection means 75 for selecting a specialist service provider;

(iii) multimedia information grabbing means 77 for grabbing multimedia information as appropriate;

(iv) multimedia information uploading means 79 for uploading the multimedia information to the central server station 21;

(v) information submission means 81 for submitting the client information to the central server station 21; and

(vi) specialist service provider advisory means 83 for advising the selected specialist service provider at a specialist service provider station 15 by email in relation to the client information.

With respect to the specialist service provider station processes 85, the following processes are provided for and performed in a controlled and regulated manner by virtue of the Web pages downloaded to the specialist service provider service station 15 by the application Web server 23:

(i) client information accessing means 87 for accessing the client information referred to the specialist service provider;

(ii) reviewing and editing means 89 for reviewing and editing the information;

(iii) reporting means 91 for enabling the specialist service provider to perform a diagnosis and report same on the information;

(iv) information submission means 93 for submitting the edited and reported aspects of the client information to the central server station 21; and

(v) primary service provider advisory means 95 for advising the referring primary service provider at the primary service provider station 14 by email that the diagnosis has been completed.

With respect to the primary service provider station processes 97, the following processes are provided for and performed in a controlled and regulated manner by virtue of the Web pages downloaded to the primary service provider service station 14 by the application Web server 23 to enable restricted access to the client information of a patient:

(i) criteria entry means 99 for enabling searching of client information via prescribed searching criteria;

(ii) searching means 101 to conduct the search of the DBMS;

(iii) listing means 103 to list the patient information selected by the search criteria.

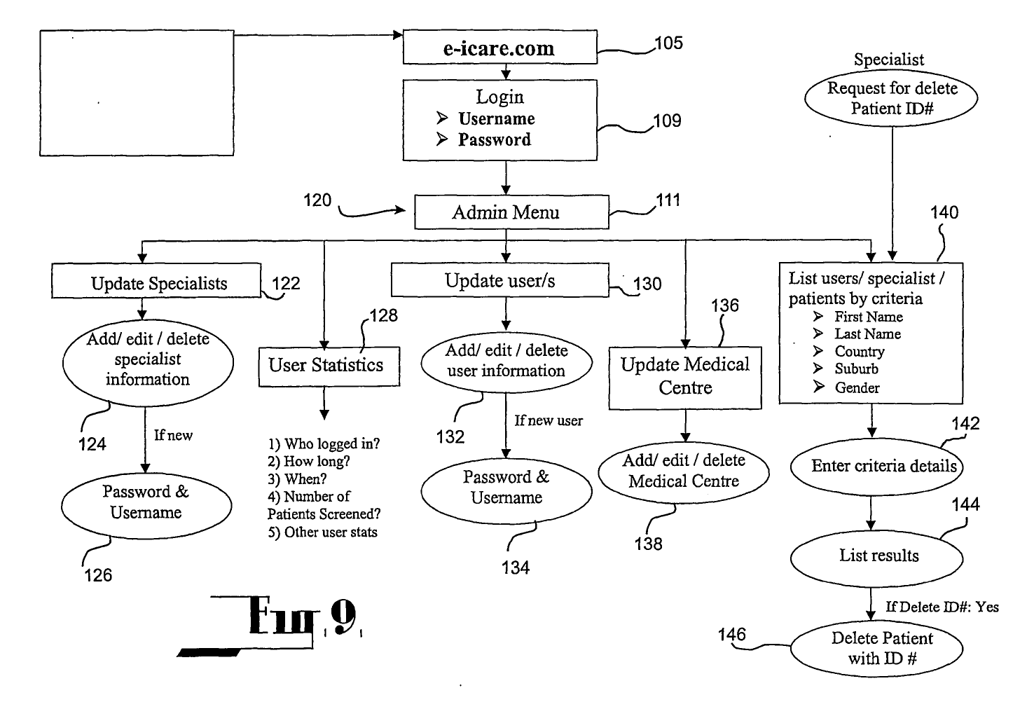

Having regard to the administration processes 120, reference is made to FIG. 9, and the following processes are provided for and performed in a controlled and regulated manner by virtue of the web pages downloaded to an administrator station 16 by the application Web server 23:

(i) specialist updating means 122 for updating specialist information particulars, which includes specialist modifying means 124 for adding, editing or deleting specialist information; and specialist login information adding means 126 for adding usernames and passwords for new specialists.

(ii) user statistics providing means 128 for providing information regarding who used the system, when and for how long, the number of patients screened, as well as additional user statistics, as required

(iii) user updating means 130 for updating user information particulars, which includes user modifying means 132 for adding, editing, or deleting user information, and user login information adding means 134 for adding usernames and passwords for new users.

(iv) medical centre updating means 136 for updating medical centre information particulars, which includes medical centre modifying means 138 for adding, editing, or deleting medical centre information.

(v) user/specialist/patient searching means 140, which includes criteria entry means 142 for enabling the administrator to search client information in the DBMS via prescribed searching criteria, result display means 144 for displaying the results of the search, and patient record delete means 146 for enabling the administrator to delete patient information identified with a patient ID. The deletion of patient records is only carried out in response to a request from a specialist—who will send details of the patient ID to the administrator, who will use that patient ID to delete the appropriate patient record from the DBMS.

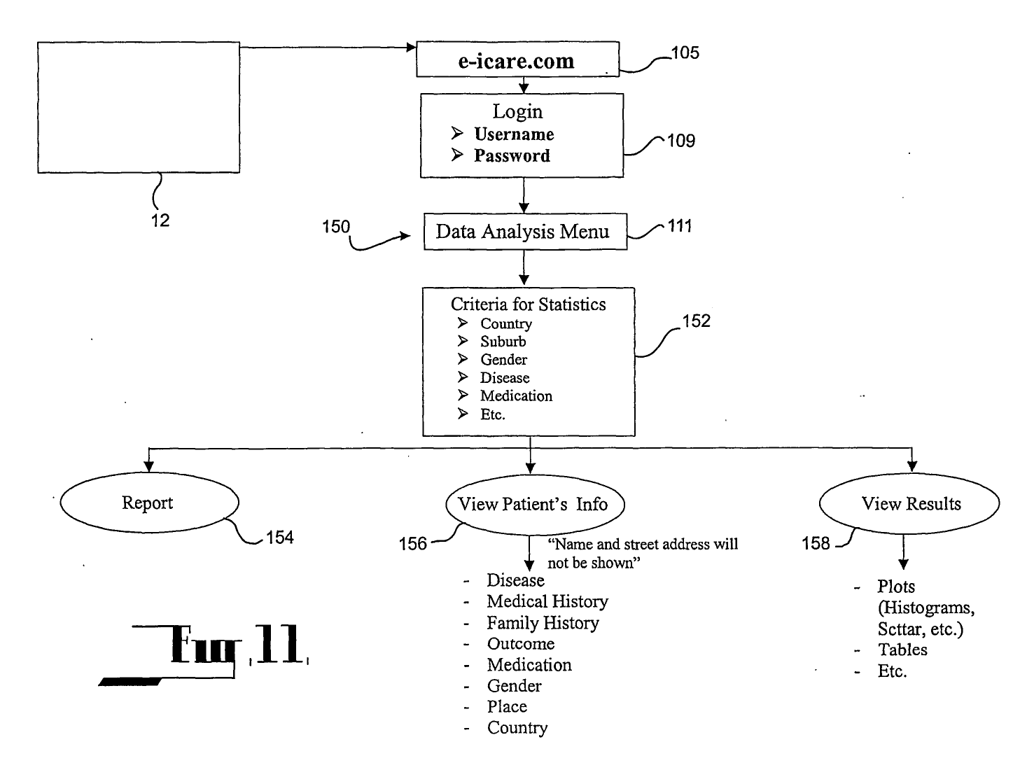

With respect to the analysis station 18, reference is made to FIG. 11, and the following analysis processes 150 are provide for and performed in a controlled and regulated manner by virtue of the Web pages downloaded to the analysis station 18 by the application Web Server 23:

(i) criteria searching means 152 for enabling searching of information stored in the DBMS on the basis of criteria such as location (country, suburb), gender, disease, medication, or any other criteria

(ii) report providing means 154 for providing a report of the results arising from the search

(iii) patient information display means 156, which can display patient information such as disease, medical history, family history, outcome, medication, gender, and location. However, means of identifying the patient—such as name and address—will not be displayed.

(iv) result display means 158, which will display the statistical results of the search in appropriate formats such as plots, and tables, or any other suitable format.

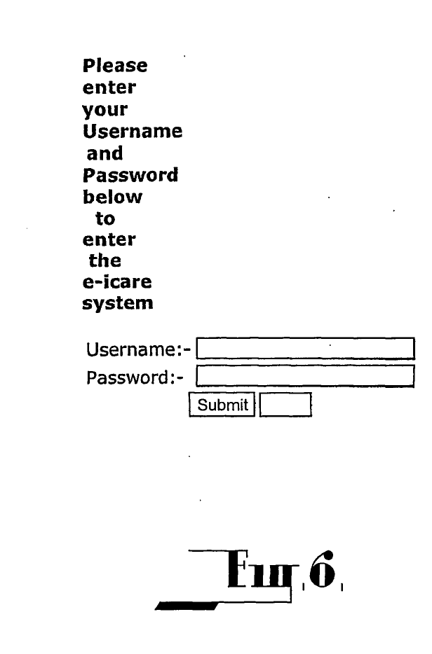

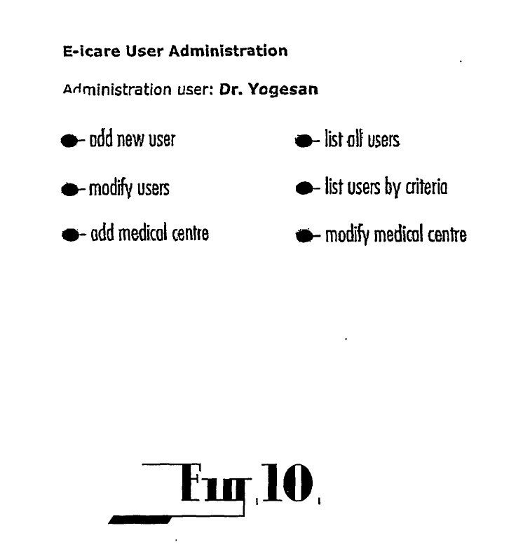

The Web site of the central service station 21 is designed for initial access by a client 12 to a home page 105 that may carry suitable advertising and sales related information 107. The client is any user of the system, and may be client service provider—i.e. the provider the operates/provides the client service station 13, a primary service provider such as a GP, or a specialist service provider such as an ophthalmologist. The client 12 then accesses a login page 109, shown in FIG. 6, to access further levels of the central server station 21. After successfully completing the login stage, the client is presented with a prescribed menu page 111, the content of which will depend upon the access level privileges of the client and the client type, whether they be a client service provider, a primary service provider, specialist service provider, or the administrator or carrying out data analysis. The access level will depend upon the client type. The menu page then allows access to the various processes under the process heads 71, 85, 97, 150 and 120 in a controlled and regulated manner according to the client type. As mentioned above, the options available to the user will depend upon their ascribed access level. Options that are not available to the particular user, will not be displayed on the menu page. FIG. 10, for example, illustrates the menu page 111 for a user with Level 3 access privileges—that is a user that is an administrator—see below. All the web pages are constructed and arranged in accordance with known techniques and include text and images as well as, where appropriate, fields for entering or retrieving data as required.

In the present embodiment, there are four different access levels, which will allow access to the data/processes:

Access level 1 (A, B, and D)—ascribed to primary healthcare professionals such as optometrists, GP's and nurses, as well as other suitably trained personnel trained to operate the client service stations 13. They will have access to screen new patients, edit and/or update patients' information, search and view previously screened patients information (screened by the same user), and to send queries to specialists. This access level will not allow the user to delete any patient's information that has already been submitted to a specialist. This data can, however, be deleted by an administrator, upon request. This is described in more detail below. Thus, a user with this access level will have access to the processes identified by “A”, “B” and “D” in FIG. 5.

Access Level 2—ascribed to specialists such as ophthalmologists. This provides full access to their patient's information and will allow them to add new patients, screen new patients, review, edit and delete patient data. It will also allow them to write diagnoses for their own patient's. Thus, a user with this access level will have access to the processes identified by “A”, “B”, “C” and “D” in FIG. 5.

Access Level 3—ascribed to an administrator using the administrator station 16. This user will have complete administrative access to the system 11, and will be able to create a new user—including adding passwords and user name), and update the specialists using the system. The administrator can also produce user statistics such as who uses the system, and for how long and how often, the number of patient's screened in any given time period, remove a user and view patient information. However, the administrator will not have access to edit or delete patient information without permission from the appropriate user.

Access Level 4—allows access to data for data analysis. This allows a user to search, view and obtain statistical information from the database using an analysis station 18.

Web pages corresponding to selected processes, as shown in the drawings, are as follows:

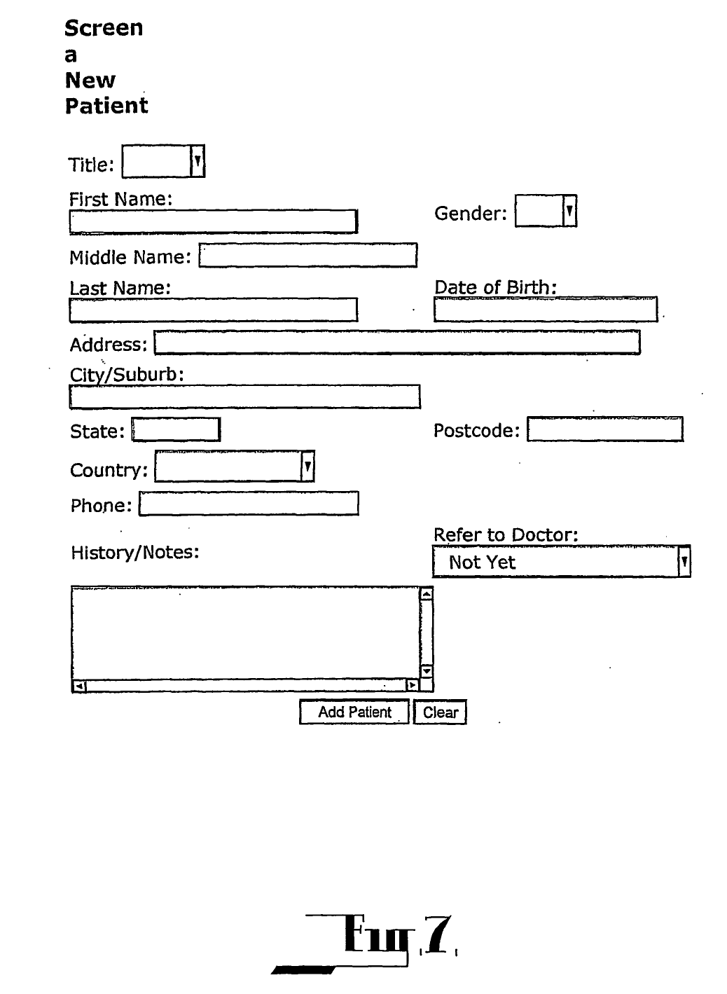

vital client information gathering means 73 listing the information to be input in relation to the patient is shown at FIG. 7

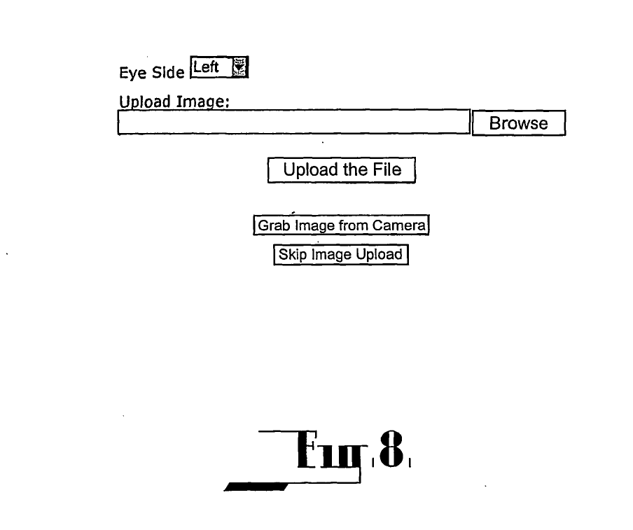

multimedia information grabbing means 77 for grabbing and uploading image, and/or video information in relation to the patient is shown in FIG. 8

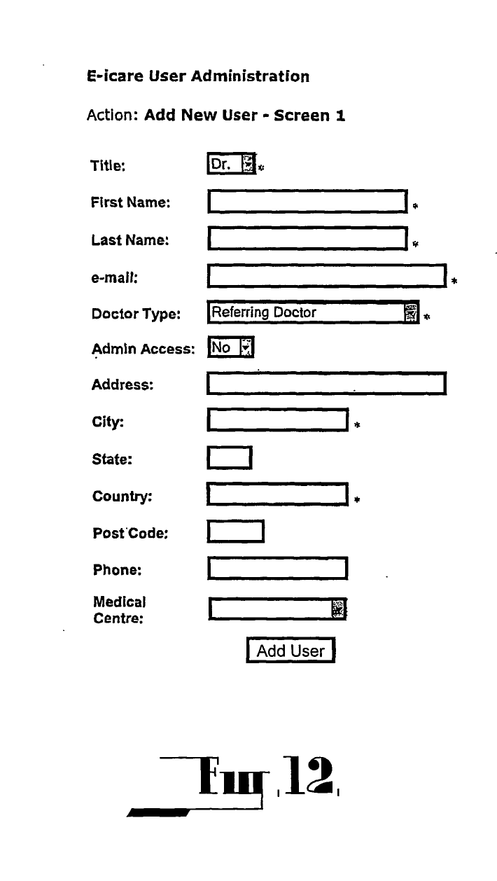

user modifying means 132 listing the information to be input to add a new user to the system 11 is shown in FIG. 12

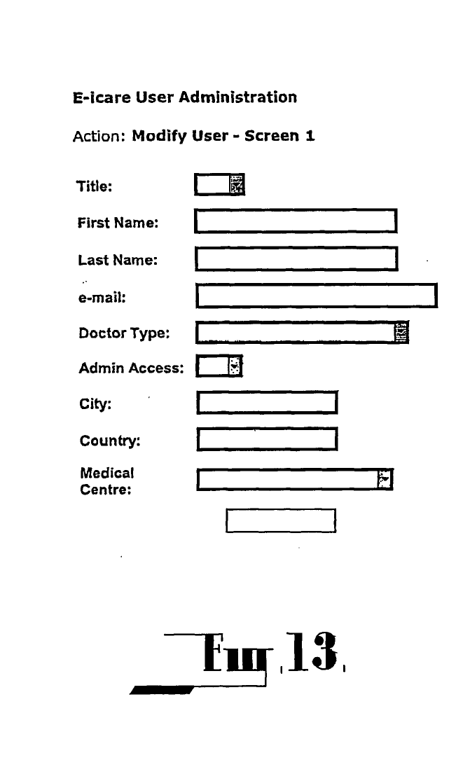

user modifying means 132 listing information to be input to modify user information is shown in FIG. 13

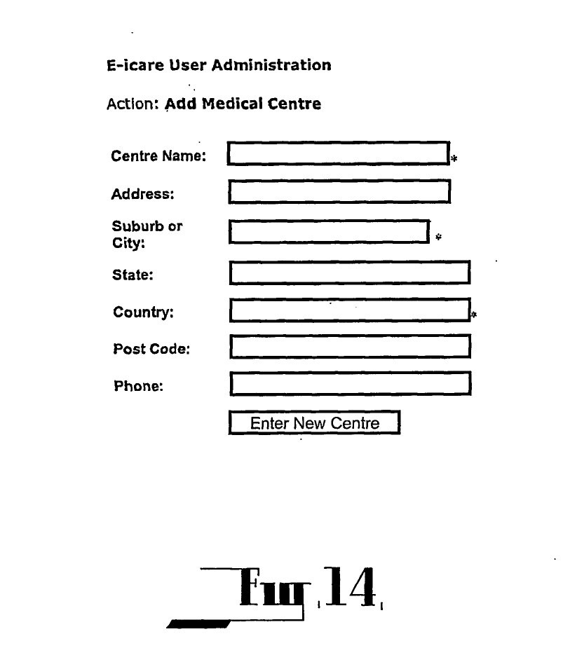

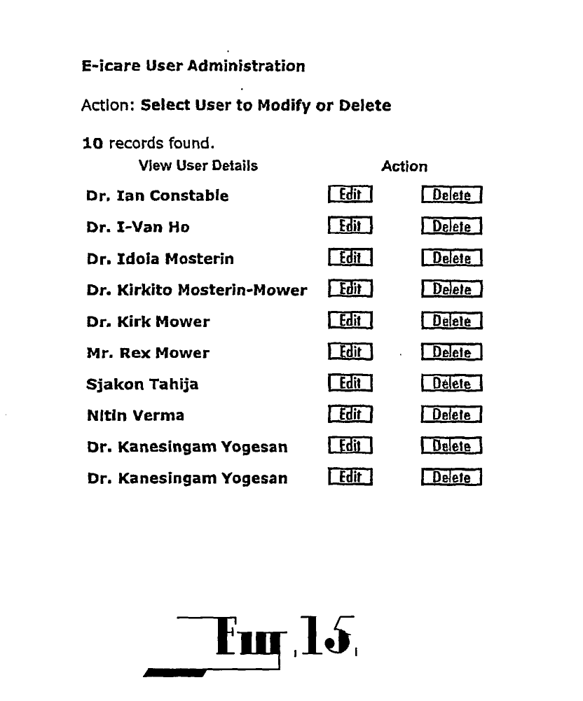

medical centre modifying means 138 listing information to be input to add a new medical centre to the system 11 is shown in FIG. 14

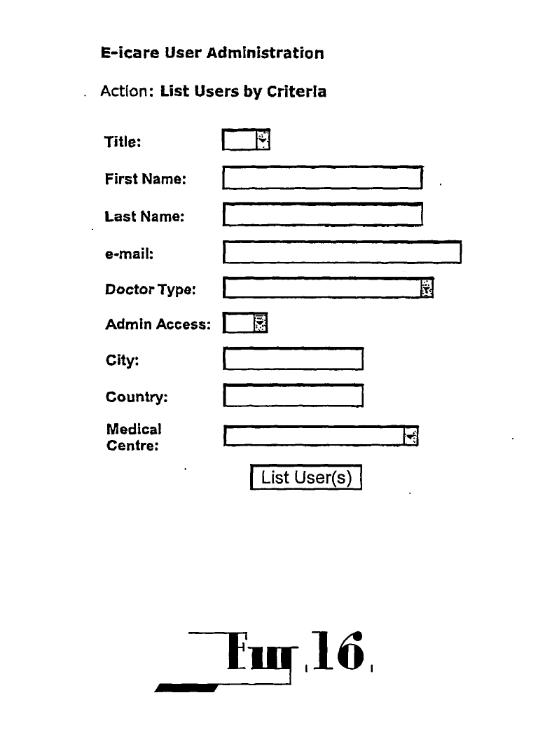

result display means 144 displaying the results of a search using the user/ specialist/patient searching means 140, under the criteria of “all users” is shown in FIG. 16. This particular result can be made available to the administrator directly through the menu 111—see FIG. 10—rather than the administrator having to select this criteria initially

criteria entry means 142 listing criteria that can be selected for searching by is illustrated in FIG. 16

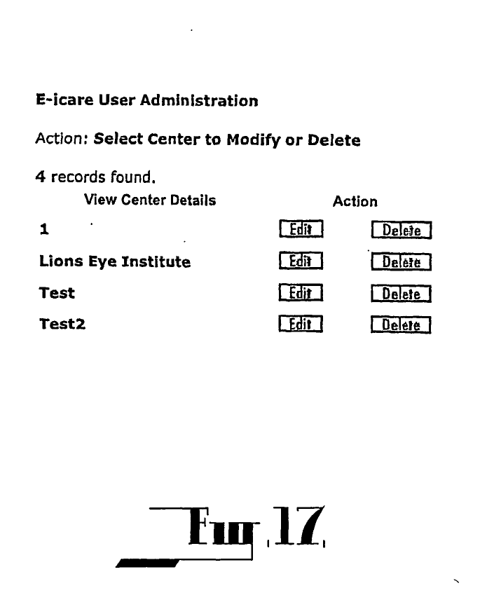

medical centre update 136 means displaying the medical centres with details stored in the DBMS from which the administrator can select one to modify is illustrated in FIG. 17

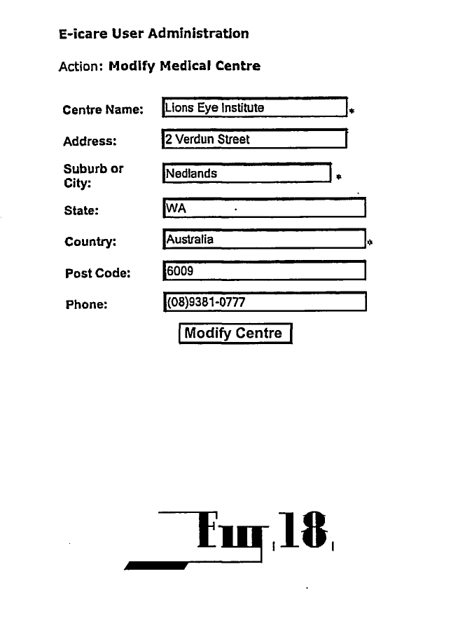

medical centre modifying means 138 listing the information for the selected medical centre that can be modified is illustrated in FIG. 18.

All other web pages can be similarly structured to allow users to enter or retrieve data, and to administer the system—as appropriate.

Thus the virtual service system 11 effectively provides a browser-based system for sending patient's demographical details, images and videos to specialists/ophthalmologists through the Internet. The GPs, optometrists and middle level health care personnel can use their Internet browser to access the Web site of the central service station. They can login to the database to add patient's information, grab still images and videos to send to the ophthalmologists. The referring doctor/optometrist can choose the ophthalmologist to whom the patient will be referred.

In operating the virtual service system of the present embodiment, the following features are noteworthy:

1) Referring doctor/optometrist has to subscribe to get a username and password to access the system.

2) Subscription fees for maintenance of the centralised server and database and backups are charged to the users of the system.

3) Referring doctor/optometrist can insert patient's information, still images, videos and audio annotations.

4) Referring doctor/optometrist can choose the ophthalmologists to use for the screening.

5) Automatic email will be created and sent to the appropriate ophthalmologist saying that a new patient with client information is waiting for them to diagnose at the Web site of the central server system.

6) Participating ophthalmologists have to subscribe to get a username and password to access the database.

7) Ophthalmologist can write the comments/diagnosis directly into the system. The system will automatically send an email to the referring doctor about the diagnosis.

8) Image processing facilities are attached to each image such that the image can be zoomed, text annotations can be added, brightness and contrast can be changed etc.

9) It is possible to create a patient report and print a hard copy.

10) Search facility is also implemented—e.g. search for a patient, suburb.

11) Image and video grabbing are provided directly from the browser.

12) Images are compressed and uploaded to the centralised server.

The advantages of such a virtual service system are many and varied, including:

Less skilled persons can screen patients (because screening becomes image collection). Therefore cost saving to the health system.

Potential for more patients to be screened and for earlier detection of disease. Therefore potential for more eye disease to be treated (alleviated) because of earlier detection of more patients.

Potential for more treatment cost/revenue but reduced cost to the community of managing visually impaired citizens.

Off-site diagnosis based on a review of the images (6-10 per patient).

Patient only needs one visit for screening. Therefore time and cost saving to the patient (no referral and waiting time to the patient).

Patient can get results of screening within typically 3 days for example—accelerated result in comparison to referral delays. Therefore a more timely service.

Ophthalmologist conducts diagnosis from images not patient. Estimated 6-8 times more efficient (less time) for ophthalmologist.

Transmission of images in a secured fashion over the Internet. Transmission by ISDN line is also possible.

With transmission to patients etc over the Internet, potential for advertising and sale of other related services and products.

Provision of diagnosis services and/or granting ophthalmologists access to data bank.

Patient management records software system (integrating images and patient records, billing and appointments) to replace existing hard copy records management system.

Less consultation time—i.e. one-stop shop for diagnosis—and therefore easier access to diagnosis and less time used in the process (waiting and consultation time).

Access to diagnosis for more patients—e.g. traditional market for tele-medicine in rural health.

Potentially less cost.

the optometrist gets to provide a wider service to the customer—i.e. facilitating the diagnosis process and maintaining the direct contact with the patient.

Only if a patient falls within the approximately 4% treatment category will referral to the ophthalmologist be required. Therefore the optometrist maintains more control of the patient.

Similarly an increased role for the GP, technician and nurse.

Optometrists will have a reduced role if automated screening instruments are adopted and technology becomes accepted—i.e. no personal consultation is required to gather the images, except perhaps a drug store shop assistant.

For some ophthalmologists, less screening function.

For screening activities retained by the patient, patient records management function will be much more efficient—e.g. retention of digital images. Other advantages include easy automated reporting; less administration and filing hassles and less storage space is required.

Ophthalmologists' diagnosis activity should be 6-8 times more efficient than the current consultation process. Therefore a time saving for the prominent ophthalmologists. *

Access to the data bank (i.e. the patient pool) could become competitive.

Knowledge of the persons requiring treatment is a valuable asset—can do the treatment.

Pool of persons requiring treatment may be larger than present (due to more images for diagnosis and earlier-stage images).

It should be appreciated that the scope of the present invention is not limited to the specific mode of the invention described herein. Accordingly obvious changes to the hardware and application software can be made to adapt the virtual service system and method to services other than ophthalmic screening, without departing from the spirit of the inventive concept of the invention and thus are envisaged to fall within the scope of the invention. The system can be equally adapted to be used to screen and diagnose disease in other areas of medicine, such as dental diseases.

The claims defining the invention are as follows:

1. A virtual service system for providing a service to a client, the system comprising:
a client service station for acquiring information about the client, and providing to a user thereat a plurality of client processes for acquiring said information in a controlled and regulated manner;
a central server station for receiving and storing the acquired information about the client in a prescribed manner, the central server station comprising multiple discrete servers;
a primary service provider station for facilitating the acquisition and transfer of said information to said central server station; and
a specialist service provider station for accessing information stored at the central server station, and providing to the user thereat a plurality of specialist processes in a controlled and regulated manner.

2. A virtual service system as claimed in claim 1, wherein each discrete server of the central server station receives and stores acquired information of a predetermined type.

3. A virtual service system as claimed in claim 1, wherein the specialist service provider station accesses the information stored at the central server station by having the central server station transmit the information to the specialist service station in accordance with a prescribed protocol at a time specified by the specialist service station.

4. A virtual service system as claimed in claim 3, wherein the prescribed protocol includes transmitting a low-resolution image at first instance and, thereafter, allowing a region of interest of the image to be selected at the specialist service provider station and transmitting the portion of the image equating to the region of interest at full resolution.

5. A virtual service system as claimed in claim 1, wherein the client processes include:
vital client information gathering means;
specialist service provider selection means;
multimedia information grabbing means;
multimedia information uploading means to said central server station;
information submission means to said central server station; and
specialist service provider advisory means to said specialist service provider station.

6. A virtual service system as claimed in claim 1, wherein the specialist processes include processes for accessing, processing and editing the information, and include:
client information accessing means;
reviewing and editing means of said information;
reporting means in respect of said information;
information submission means for submitting the edited and reported aspects of said client information to said central server station; and
primary service provider advisory means to said primary service provider station.

7. A virtual service system as claimed in claim 1, wherein the primary service provider station has a prescribed primary level access to the information stored at the central server station, the prescribed primary level access permitting only reading of the information.

8. A virtual service system as claimed in claim 1, wherein the specialist service provider station has a prescribed specialist level access permitting reading and writing of the information.

9. A virtual service system as claimed in claim 1, wherein the primary service provider station corresponds to the client service station.

10. A virtual service system as claimed in claim 5, wherein the primary service provider station is discrete from the client service station.

11. A virtual service system as claimed in claim 1, and further including an administrator station for providing to a user thereat a plurality of administrative processes for administering the system in a controlled and regulated manner.

12. A virtual service system as claimed in claim 11, wherein the administrative processes include:
specialist updating means;
user statistic providing means;
user updating means;
medical centre updating means; and
searching means for searching information stored at the central server station.

13. A virtual service system as claimed in claim 1, and further including an analysis station for providing to a user thereat a plurality of analysis processes for providing an analysis of the information stored in the system in a controlled and regulated manner.

14. A virtual service system as claimed in claim 13, wherein the analysis processes include:
criteria searching means;
report providing means; and
information display means.

15. A virtual service system as claimed in claim 14, wherein the information display means includes patient display means.

16. A virtual service system as claimed in claim 14, wherein the information display means is a result display means.

17. A method for providing a service to a client as a virtual service, the method including the steps of:
acquiring information about a client at a client service station by following a plurality of client processes in a controlled and regulated manner;
transferring the information to a central server station comprising multiple discrete servers where the information is stored in a prescribed manner;
facilitating the acquisition and transfer of said information to the central server station via a primary service provider station; and
accessing the stored information at the central server station from a specialist service station by following a plurality of specialist processes.

18. A method as claimed in claim 17, wherein the information stored at the central server station is apportioned according to predetermined types and each apportionment is stored on the discrete server designated for storage of information of the respective predetermined type.

19. A method as claimed in claim 17, wherein the step of accessing the stored information at the central server station from a specialist service station comprises, transmitting the information from the central server station to the specialist service station in accordance with a prescribed protocol at a time specified by the specialist service station.

20. A method as claimed in claim 19, wherein the prescribed protocol comprises the steps of:
receiving a low-resolution image at first instance at the specialist service provider station;
optionally selecting a region of interest of the image;
transmitting details of the selected region of interest to the central server station; and
receiving a full resolution image of the portion of the image equating to the region of interest.

21. A method as claimed in claim 17, wherein the client processes include:
gathering vital client information;
selecting a specialist service provider;
grabbing multimedia information as appropriate;
uploading the multimedia information to the central server station; submitting the client information to the central server station; and
advising the selected specialist service provider in relation to the client information.

22. A method as claimed in claim 17, wherein the method further includes the steps of processing and editing the accessed and stored information, from the specialist service station.

23. A method as claimed in claim 22, wherein the specialist processes include:
accessing the client information;
reviewing and editing of said information;
reporting in respect of said information;
submitting the edited and reported aspects of said client information to said central server station;
advising the primary service provider at the primary service provider station.

24. A method as claimed in claim 17, wherein the primary service provider station has a prescribed primary level access to the information stored at the central server station, the prescribed primary level access permitting only reading of the information.

25. A method as claimed in claim 17, wherein the specialist service provider station has a prescribed specialist level access permitting reading and writing of the information.

26. A method as claimed in claim 17, and further including the step of providing to a user, via an administrator station, a plurality of administrative processes for administering the system in a controlled and regulated manner.

27. A method as claimed in claim 26, wherein the administrative processes include:
specialist updating means;
user statistic providing means;
user updating means;
medical centre updating means; and
searching means for searching information stored at the central server station.

28. A method as claimed in claim 17, and further including the step of providing to a user, via an analysis station, a plurality of analysis processes for providing an analysis of the information stored in the system in a controlled and regulated manner.

29. A method as claimed in claim 28, wherein the analysis processes include:
criteria searching means;
report providing means; and
information display means.

30. A method as claimed in claim 29, wherein the information display means includes a patient display means.

31. A method as claimed in claim 28, wherein the information display means includes a result display means.
